(19) United States
(12) Patent Application Publication
(10) Pub. No.: US 2018/0044029 A1
(43) Pub. Date: Feb. 15, 2018

(54) COAXIAL ALIGNED ELECTRIC MOTOR GROUP FOR PROPELLING AN UNMANNED AERIAL SYSTEM

(71) Applicant: Patrick C. Koegler, Bend, OR (US)

(72) Inventors: Patrick C. Koegler, Bend, OR (US); Leslie J. Koegler, Bend, OR (US)

(21) Appl. No.: 15/233,507

(22) Filed: Aug. 10, 2016

(51) Int. Cl. B64D 27/24; B64D 47/08; H02K 7/14; B64C 39/02

(52) U.S. Cl. CPC B64D 27/24; B64C 39/024; B64D 47/08; H02K 7/14; B64C 2201/108; B64C 2201/042; B64C 2201/127

(57) ABSTRACT

A coaxial, aligned electric motor group for propelling an unmanned aerial system. The electric motor group includes a first electric motor having a first rotor and a first stator, the first rotor including as a portion thereof or supporting as an attachment thereto an axially elongate first power output shaft, and a second electric motor having a second rotor and a hollow second stator. The first power output shaft extends coaxially through the hollow second stator, and the second rotor includes as a portion thereof, or supporting as an attachment thereto, an axially elongate second power output shaft.

### FIELD OF THE INVENTION

The present invention relates to electric motors for propelling unmanned aerial vehicles or systems, and more particularly to groups of two electric motors arranged coaxially.

### BACKGROUND

Unmanned aerial vehicles or systems (hereinafter “unmanned aerial system” or “UAS”) are typically used for aerial photography, i.e., imaging the ground or objects on the ground from an elevated, “direct-down” position, and are expected to be widely used in the near future to deliver parcels. They are typically powered, for hovering or flying, by electric motors.

Electric motors comprise two primary sections, a rotor and a stator. The stator, by convention, is stationary, and the rotor spins relative to the stator.

One of the rotor and stator carries one or more permanent magnets, while the other of the rotor and stator carries one or more coils of electrically conductive wire for carrying an electrical current and thereby generating a magnetic field according to Ampere's law. The magnetic field generated by the coils interacts with the magnetic field produced by the magnets so as to cause the rotor to turn relative to the stator.

The source of electrical current that is used to drive the coils is, like the stator, stationary. In ordinary brushed DC electrical motors, the spinning rotor carries the coils. Therefore brushes, which drag across coil contact pads on the spinning rotor, are needed to make electrical connection between the source of electrical current and the coils, to provide for commutation of the electric current. Since there is faction between the brushes and the coil contact pads, the brushes are designed to sacrificially wear out in favor of preserving the contact pads, and require periodic replacement.

Alternatively, the spinning rotor may carry the magnets, with the stator carrying the coils. In that case, the coils and the source of electrical current are both stationary so no brushes are needed for commutation and the motor is termed “brushless.” In addition to providing the advantage of greater reliability and less maintenance, the “brushless” motor generally provides for more torque and therefore greater efficiency, which is a main reason why brushless motors are preferred in applications where minimizing weight and maximizing operating longevity is important, such as in a UAS.

Brushless electric motors may be of two general types, termed “inrunner” and “outrunner.” FIG. 1 illustrates the basic architecture of an inrunner brushless motor 10, in which the rotor 12 is contained within the stator 14 as is in the ordinary, brush-type electric motor; however, in contrast to the ordinary, brush-type electric motor, the rotor carries the magnets 11, and the coils 13 are attached to the stator.

In contrast to the inrunner motor, FIG. 2 illustrates the basic architecture of an outrunner brushless motor 15, in which the rotor 16 encloses the stator 18 within an outer shell or “can” portion 16a, so that the stator is inside the rotor; the rotor still carrying the magnets 17 and the coils 19 still being attached to the stator to allow for brushless operation.

Referring to FIG. 3, a prior art UAS is shown which employs eight electric motors at four corners, so that there are four groups of two electric motors. The two electric motors of a single group are typically arranged so that the shafts of the two motors rotate about the same axis, i.e., they are “coaxial.” They are also arranged in opposition, so that the output ends of the shafts of the two motors extend in opposite directions. One or more propellers is attached to each shaft at the respective output end.

Referring to the motor group 10 in particular, the propellers “P₁” and “P₂” are driven by, respectively, the motors “M₁” and “M₂” at opposite poles, relative to the axis of rotation “R,” of the group. Each of the propellers may be driven by their respective motors either clockwise or counterclockwise about the axis of rotation as needed so that they work together to provide thrust in the same desired direction.

The use of motor groups employing two motors rather than a single motor at each corner of the UAS is advantageous for providing redundancy and increased lifting capacity.

### SUMMARY

A coaxial, aligned electric motor group is disclosed herein. The electric motor group includes a first electric motor having a first rotor and a first stator, the first rotor including as a portion thereof or supporting as an attachment thereto an axially elongate first power output shaft, and a second electric motor having a second rotor and a hollow second stator. The first power output shaft extends coaxially through the hollow second stator, and the second rotor includes as a portion thereof, or supporting as an attachment thereto, an axially elongate second power output shaft.

For use in powering a UAS, the electric motor group may further include one or more first propellers attached to the first power output shaft at a first end thereof, and one or more second propellers attached to the second power output shaft at a second end thereof, wherein the first and second ends are axially disposed on the same side of the first and second stators.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a simplified schematic representation of a basic inrunner type brushless electric motor.

FIG. 2 is a simplified schematic representation of a basic outrunner type brushless electric motor.

FIG. 3 is a perspective view of a prior art UAS employing 4 groups of 2 coaxial opposed electric motors.

FIG. 4 is an isometric view of a motor group of coaxial aligned electric motors according to the present invention, with respective propellers attached thereto.

FIG. 5 is a schematic, cross-sectional view of the motor group of FIG. 4.

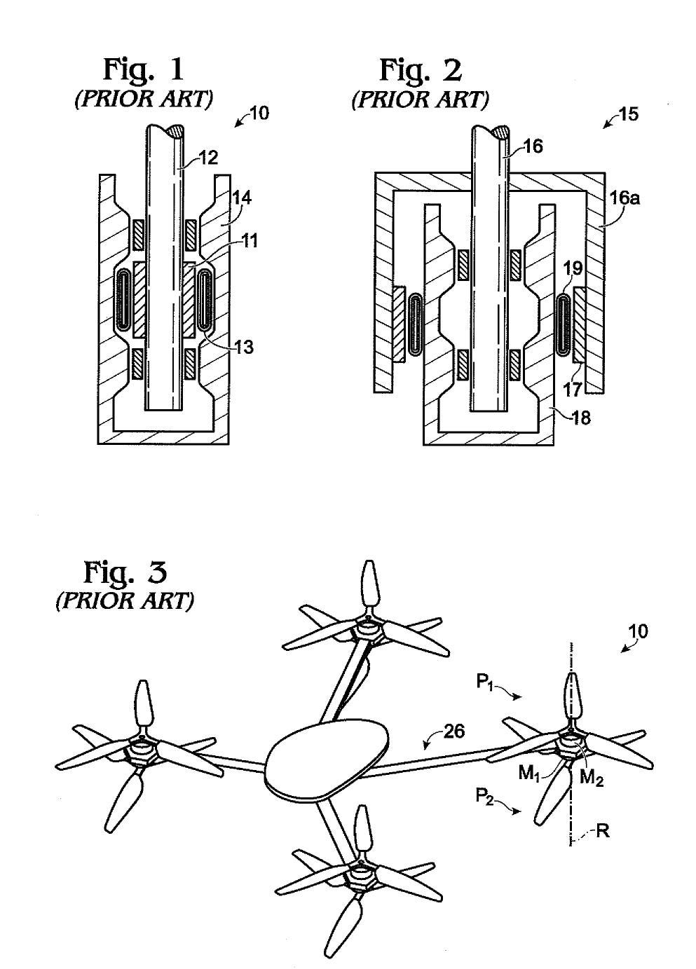

### DETAILED DESCRIPTION OF PREFERRED EMBODIMENTS

Electric motors according to the present invention are typically used to propel UAS's, which have many uses including aerial imaging, light detection and ranging (LiDAR), sound navigation and ranging (SoNAR), and thermal imaging. They are typically brushless and employ the aforedescribed outrunner architecture, but they could be other types, and they could be used for other purposes.

As noted above, such motors are typically provided in groups of two, in a coaxial, opposed configuration. Thus the propellers associated with the two motors are disposed at opposite ends of the group. The present inventor has recognized that this configuration presents packaging problems. For example, in UAS's used for aerial photography, the coaxial, opposed configuration tends to restrict the view from the camera, or other imaging or detection device, and this configuration tends to restrict the space available for carrying or delivering payloads.

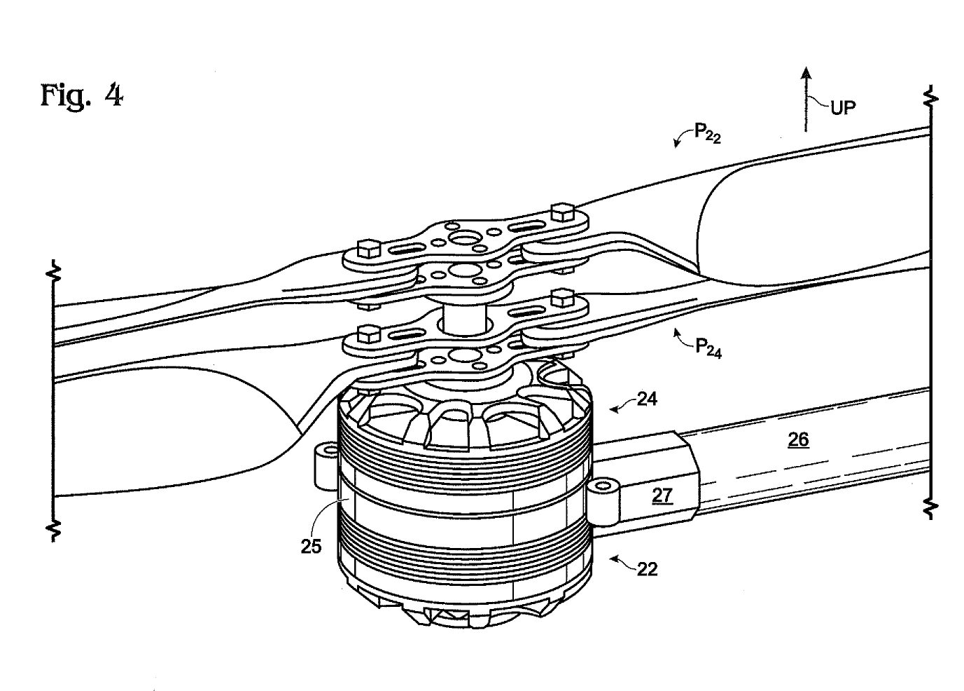

Turning to FIG. 4, to address these problems the present invention provides for an electric motor group 20 having two motors 22 and 24 in what will be termed for purposes herein a coaxial, “aligned” configuration, where the propellers P₂₂ and P₂₄ associated with the two motors are disposed at the same end of the group.

The motors 22 and 24 preferably share a common housing 25, which is mounted to an airframe 26 of the UAS. The propellers P₂₂ and P₂₄ may be disposed above the airframe 26. By contrast, any imaging device or payload carried by the UAS is typically carried below the airframe. For purposes herein, it will be understood that the terms “above” and “below” are with reference to the orientation of the UAS as it is flying, where the direction indicated in FIG. 4 is “up.”

The propellers are generically indicated in FIG. 4. It should be understood that there may be any number of propellers associated with each motor, and/or any number of blades per propeller.

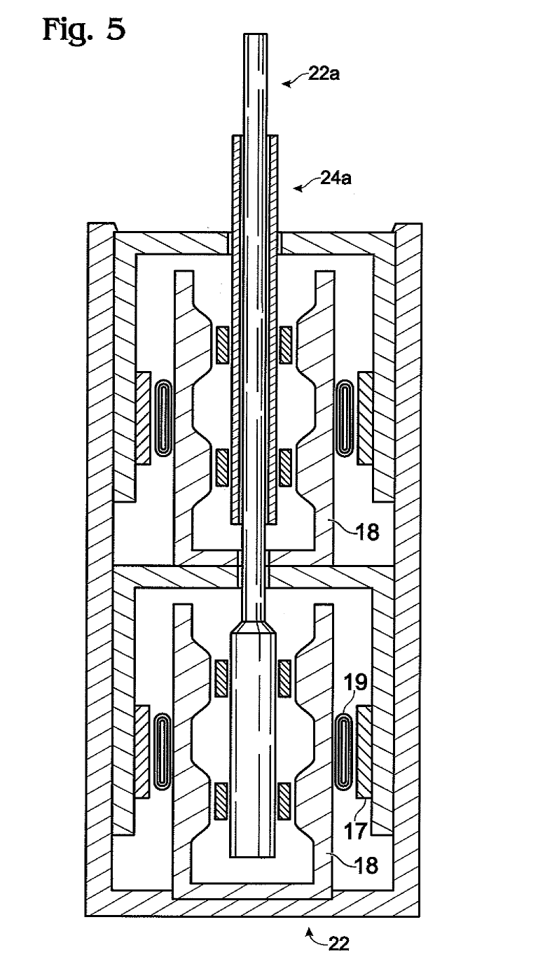

Turning to FIG. 5, to achieve the aligned configuration, the power output shaft 24a of what may be referred to as the “proximal” motor 24 (meaning proximal to the propellers) is tubular, and therefore hollow, to allow for coaxially receiving therethrough the power output shaft 22a, or an extension of the power output shaft 22a, of what may now be referred to as the “distal” motor 22.

The power output shafts 22a and 24a may be either ends or extensions of the respective rotors of the electric motors 22 and 24, or attachments thereto.

It is preferred for use in powering a UAS, but not essential, that the shafts of the motors 22 and 24 counter-rotate, with the blades of the propellers P₂₂ and P₂₄ being configured to provide for thrust in the same direction, and more particularly lift.

The coaxial aligned configuration can be achieved with any type of electric motor, although brushless motors employing outrunner architecture are preferred for use in powering UAS's. Regardless of motor type, either radial or angular contact bearings may be used for supporting the coaxially disposed power output shafts.

Turning back to FIG. 4, the coaxially aligned configuration addresses the aforementioned packaging problems by removing the need for propellers below the airframe 26, which frees up space for imaging as well as space for payloads.

Moreover, the coaxially aligned configuration allows for reducing weight, which is a particularly important advantage in a UAS, because the two motors can be provided in a single relatively compact housing 25 which can be mounted to the UAS on a single mounting platform 27, as opposed to the prior art in which the individual motors typically have separate motor housings and separate mounting platforms.

It should be understood that, while a specific coaxial, aligned electric motor group for propelling an unmanned aerial system has been shown and described as preferred, variations can be made, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A coaxial, aligned electric motor group, comprising:
a first electric motor having a first rotor and a first stator, the first rotor including as a portion thereof or supporting as an attachment thereto an axially elongate first power output shaft; and
a second electric motor having a second rotor and a hollow second stator, the first power output shaft extending coaxially through the hollow second stator, the second rotor including as a portion thereof or supporting as an attachment thereto an axially elongate second power output shaft.

2. The electric motor group of claim 1, further adapted for use in powering a UAS by including one or more first propellers attached to the first power output shaft at a first end thereof, and one or more second propellers attached to the second power output shaft at a second end thereof, wherein the first and second ends are axially disposed on the same side of the first and second stators.

3. The electric motor group of claim 2, operatively provided in the UAS having an airframe, wherein the propellers are disposed above the airframe.

4. The electric motor group of claim 3, operatively provided in the UAS along with at least one additional instance thereof.

5. The electric motor group of claim 3, operatively provided in the UAS along with at least three additional instances thereof.

6. The electric motor group of claim 5, wherein the first and second electric motors are brushless.

7. The electric motor group of claim 4, wherein the first and second electric motors are brushless.

8. The electric motor group of claim 3, wherein the first and second electric motors are brushless.

9. The electric motor group of claim 2, wherein the first and second electric motors are brushless.

10. The electric motor group of claim 1, wherein the first and second electric motors are brushless.

11. The electric motor group of claim 10, wherein the first and second electric motors have outrunner architecture.

12. The electric motor group of claim 9, wherein the first and second electric motors have outrunner architecture.

13. The electric motor group of claim 8, wherein the first and second electric motors have outrunner architecture.

14. The electric motor group of claim 7, wherein the first and second electric motors have outrunner architecture.

15. The electric motor group of claim 6, wherein the first and second electric motors have outrunner architecture.

16. The electric motor group of claim 15, wherein the unmanned aerial system carries an imaging device disposed below the propellers.

17. The electric motor group of claim 14, wherein the unmanned aerial system carries an imaging device disposed below the propellers.

18. The electric motor group of claim 13, wherein the unmanned aerial system carries an imaging device disposed below the propellers.

19. The electric motor group of claim 8, wherein the unmanned aerial system carries an imaging device disposed below the propellers.

20. The electric motor group of claim 7, wherein the unmanned aerial system carries an imaging device disposed below the propellers.

21. The electric motor group of claim 6, wherein the unmanned aerial system carries an imaging device disposed below the propellers.

22. The electric motor group of claim 5, wherein the unmanned aerial system carries an imaging device disposed below the propellers.

23. The electric motor group of claim 4, wherein the unmanned aerial system carries an imaging device disposed below the propellers.

24. The electric motor group of claim 3, wherein the unmanned aerial system carries an imaging device disposed below the propellers.
